(19) United States
(12) Patent Application Publication
(10) Pub. No.: US 2024/0044457 A1
(43) Pub. Date: Feb. 8, 2024

(54) FOOT FOR A PORTABLE PRESSURIZED GAS CYLINDER

(71) Applicant: AMTROL Licensing Inc., West Warwick, RI (US)

(72) Inventors: Tiago Texeira Rego de Oliveira, Porto (PT); Carlos Aguiar, Porto (PT); Pedro Alexandre Queiros Oliveira Silva Vieira, Matosinhos (PT)

(21) Appl. No.: 18/354,969

(22) Filed: Jul. 19, 2023

Related U.S. Application Data
(60) Provisional application No. 63/395,615, filed on Aug. 5, 2022.

(51) Int. Cl. F17C 13/08

(52) U.S. Cl. CPC F17C 13/084; F17C 2203/0604; F17C 2205/018; F17C 2250/0404

(57) ABSTRACT

Provided is a portable gas cylinder including a gas tank having an upper portion, a lower portion, and a collar, the collar including a base secured to the lower portion, a flange extending around and radially outwardly from the base, and a plurality of notches circumferentially spaced around the flange, and a foot ring configured to be attached to the gas tank, the foot ring including a base having an inner surface, an outer surface, a central portion, and a ledge extending around and inward from the central portion, a plurality of circumferentially spaced deflectable longitudinal lock tabs radially outwardly spaced from the central portion for securing the foot ring to the tank, and a plurality of circumferentially spaced rotational lock tabs radially outwardly spaced from the central portion.

### RELATED APPLICATIONS

This application claims the benefit of U.S. Patent Application No. 63/395,615 filed Aug. 5, 2022, which is hereby incorporated herein by reference.

### TECHNICAL FIELD

In general, the present invention relates to a portable pressurized gas cylinder, and in particular to a foot for a portable pressurized gas cylinder.

### BACKGROUND OF THE INVENTION

A variety of pressurized gas cylinders have been used for storage and transportation of pressurized gas products for household and industrial. For example, the cylinders may be used for the storage of gas for cooking appliances such as stoves or grills. Many of these cylinders have traditionally been fabricated of steel with a steel cylindrical body having a valve at the top for controlling the flow of gas from the cylinder and a footing at the bottom to provide stability for the cylinder upon a supporting surface. When steel cylinders are taken indoors, for example, inside a kitchen or into other living areas of the home, the footing tends to leave rust stains on the flooring or carpeting of the home.

### SUMMARY OF THE INVENTION

In accordance with an embodiment of the present invention, a foot ring configured to be secured to a tank having a collar is provided. The foot ring includes a base having an inner and outer surface and a central portion, a plurality of circumferentially spaced deflectable longitudinal lock tabs radially outwardly spaced from the central portion for securing the foot ring to the tank, each of the circumferentially spaced deflectable longitudinal lock tabs having a first portion for abutting a radially outer surface of a base of the collar and a second portion for engaging an underside of a flange of the collar that extends radially outwardly from the base of the collar, and a plurality of circumferentially spaced rotational lock tabs radially outwardly spaced from the central portion, each of the circumferentially spaced rotational lock tabs configured to be received in a respective notch in the flange to prevent rotational movement of the foot ring relative to the tank.

A portable gas cylinder includes a gas tank having an upper portion, a lower portion, and a collar, the collar including a base secured to the lower portion, a flange extending around and radially outwardly from the base, and a plurality of notches circumferentially spaced around the flange, and a foot ring configured to be attached to the gas tank. The foot ring includes a base having an inner surface, an outer surface, a central portion, and a ledge extending around and inward from the central portion, a plurality of circumferentially spaced deflectable longitudinal lock tabs radially outwardly spaced from the central portion for securing the foot ring to the tank, and a plurality of circumferentially spaced rotational lock tabs radially outwardly spaced from the central portion.

A sensor assembly configured to measure one or more parameters of a gas tank includes one or more sensors configured to detect one or more parameters of the gas tank, a control circuit configured to receive a measurement of the one or more parameters from the one or more sensors, and transmit a signal containing the measurement, one or more power supplies configured to supply power to at least one of the one or more sensors or the control circuit, and a housing that encloses the one or more sensors, the control circuit, and the one or more power supplies. The housing includes a first surface, a second surface opposite the first surface, and a cylindrical sidewall extending between the first surface and the second surface.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a bottom perspective view of a portable gas cylinder.

FIG. 2 is an exploded bottom perspective view of the portable gas cylinder.

FIG. 3 is another bottom perspective view of the portable gas cylinder.

FIG. 4 is a bottom perspective view of an exemplary foot ring of the portable gas cylinder.

FIG. 5 is a top perspective view of the foot ring.

FIG. 6 is a bottom view of the foot ring.

FIG. 7 is a top view of the foot ring.

FIG. 8 is a side view of the foot ring.

FIG. 9 is a side perspective view of the foot ring.

FIG. 10 is a perspective view of the foot ring being attached to a gas tank.

FIG. 11 is a cross-sectional view of the foot ring of FIG. 10.

FIG. 12 is still another perspective view of the foot ring being attached to the gas tank.

FIG. 13 is a cross-sectional view of the foot ring of FIG. 12 being attached to the gas tank.

FIG. 14 is a cross-sectional view of the foot ring of FIG. 12 being attached to the gas tank.

FIG. 15 is a cross-sectional view of the foot ring attached to the gas tank of FIG. 1.

FIG. 16 is a schematic diagram showing interactions with a cloud-based system.

FIG. 17 is a schematic view of a portable gas cylinder.

FIG. 18 is a perspective view of a sensor assembly.

FIG. 19A is a perspective view of a portion of a sensor assembly.

FIG. 19B is a top view of internal components of a sensor assembly.

FIG. 20 is a perspective view of a second surface of a sensor assembly.

FIG. 21 is a cross-sectional view of a sensor assembly.

FIG. 22 is a schematic diagram of a sensor assembly.

FIG. 23 is a schematic diagram of a control circuit.

FIG. 24 is a perspective view of a sensor assembly being attached to a foot ring.

FIG. 25 is a perspective view of a sensor assembly attached to a foot ring.

FIG. 26A is a top perspective view of a locking ring.

FIG. 26B is a bottom perspective view of a locking ring.

FIG. 27 is a perspective view of a locking ring being attached to a foot ring.

FIG. 28 is a perspective view of a locking ring attached to a foot ring.

### DETAILED DESCRIPTION OF THE INVENTION

Embodiments of the invention relate to methods and systems that relate to a portable gas cylinder. The cylinder has a gas tank having an upper portion, a lower portion, and a collar, the collar including a base secured to the lower portion, a flange extending around and radially outwardly from the base, and a plurality of notches circumferentially spaced around the flange. The cylinder also includes a foot ring configured to be attached to the gas tank. The foot ring includes a base having an inner and outer surface and a central portion, a plurality of circumferentially spaced deflectable longitudinal lock tabs radially outwardly spaced from the central portion for securing the foot ring to the tank, each of the circumferentially spaced deflectable longitudinal lock tabs having a first portion for abutting a radially outer surface of a base of the collar and a second portion for engaging an underside of a flange of the collar that extends radially outwardly from the base of the collar, and a plurality of circumferentially spaced rotational lock tabs radially outwardly spaced from the central portion, each of the circumferentially spaced rotational lock tabs configured to be received in a respective notch in the flange to prevent rotational movement of the foot ring relative to the tank.

With reference to the drawings, like reference numerals designate identical or corresponding parts throughout the several views. However, the inclusion of like elements in different views does not mean a given embodiment necessarily includes such elements or that all embodiments of the invention include such elements. The examples and figures are illustrative only and not meant to limit the invention, which is measured by the scope and spirit of the claims.

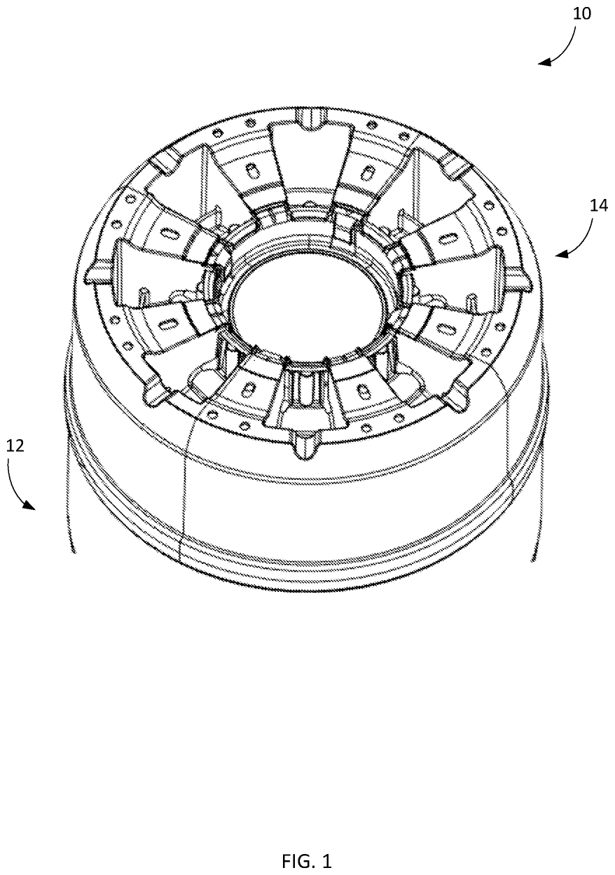

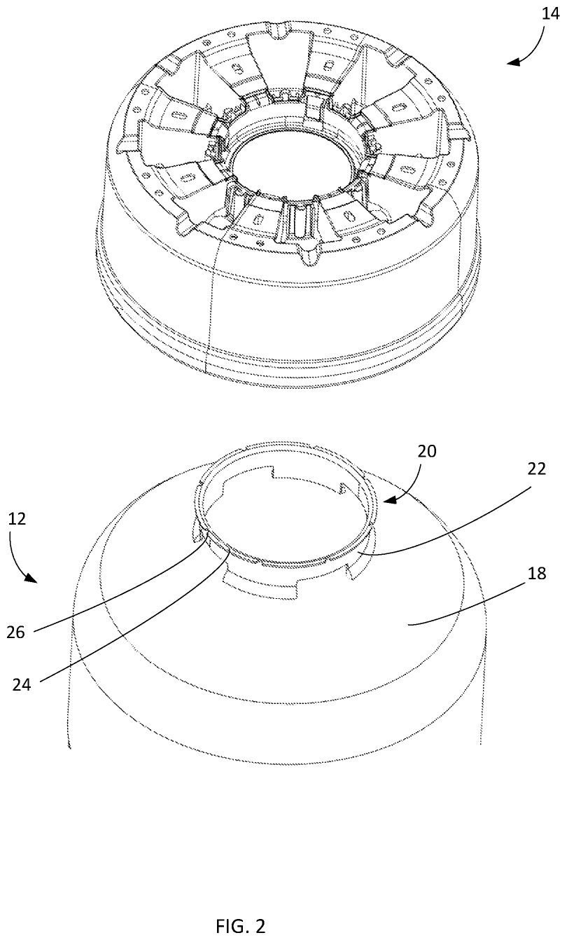

Turning now to FIGS. 1 and 2, a portable gas cylinder is shown generally at reference numeral 10. The portable gas cylinder 10 is shown with a bottom of the cylinder facing up and a top of the cylinder facing down. The gas cylinder 10 includes a gas tank 12 configured to store a suitable pressurized gas, and a cylinder stand or foot ring 14 attached to the gas tank 12. It should be appreciated that while the term gas tank 12 is used herein, gas tank 12 can be any type of tank that can contain a fluid or gas. The gas tank 12 may be made of a suitable material, such as metal, and the foot ring 14 may be made of a suitable non-metal material, such as plastic. The gas tank 12 includes an upper portion (not shown) having a valve port (not shown), a lower portion 18, and a collar 20 secured to the lower portion 18. A suitable handle assembly may be attached to the gas tank 12 at the upper portion. The gas tank 12 can include one or more liners of a material. For instance, the gas tank 12 can include a liner made of a first material, which may be at least one of a plastic, a metal, a steel, a thermoplastic, among others. In certain embodiments, the container can include a wrapping of a second material, which may be at least one of a carbon fiber, a composite material, a Teflon, or a disparate material from the first material.

The collar 20 may be secured to the lower portion 18 in any suitable manner, such as by welding, or may alternatively be integrally formed with the lower portion 18. The collar 20, which is shown as a circular collar, includes a base 22 that is attached to the lower portion 18, and a flange 24 extending around and radially outwardly from the base 22. The flange 24 includes a plurality of notches 26 circumferentially spaced around the flange 24 inward from an edge of the flange 24. The collar 20 may be made of a suitable material, such as metal, and may be made in a suitable manner, such as pressing. The notches 26 prevent the metal collar 20 from cracking as it is bent during pressing and additionally serve to assist in locating the foot ring 14 as will be described below in detail.

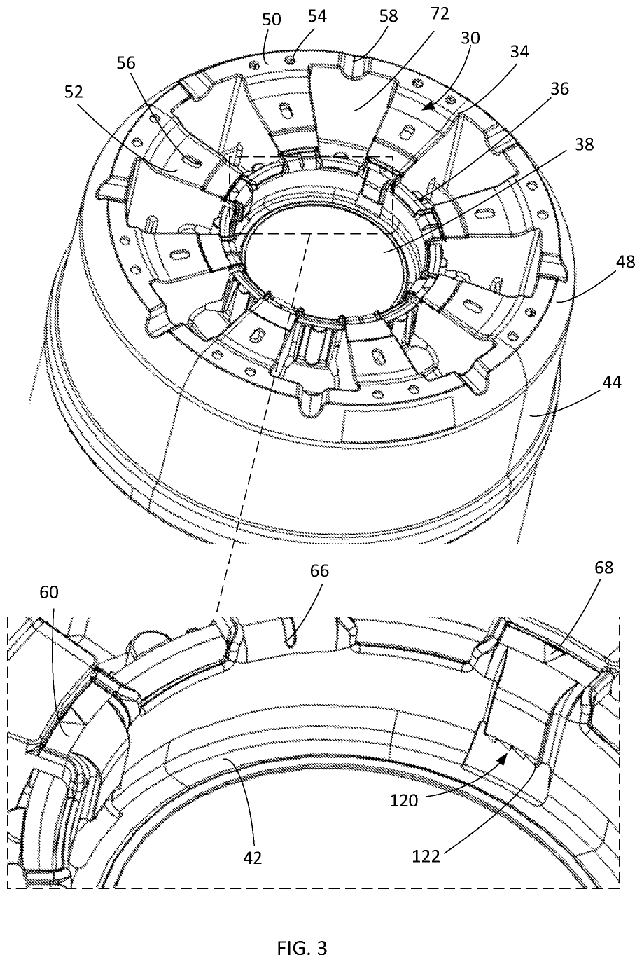

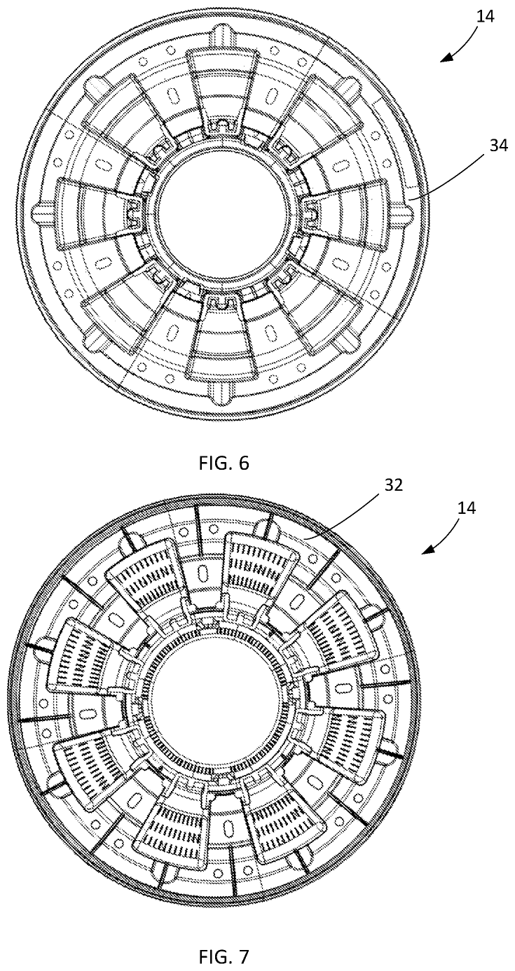

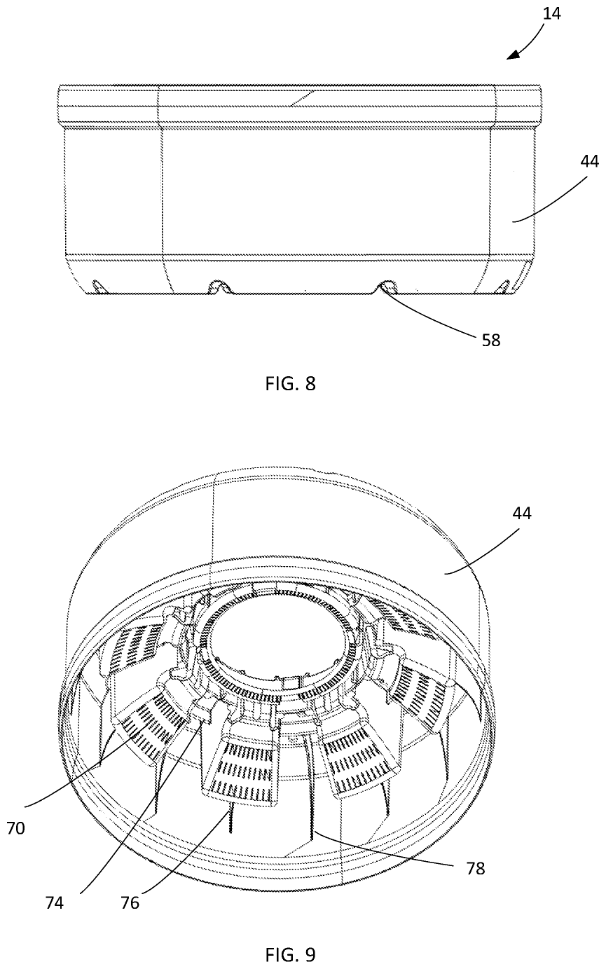

Turning now to FIGS. 3-9, the foot ring 14 will be described in detail. The foot ring 14 may be formed in any suitable manner, such as by molding, and may be formed as one piece as shown or as multiple pieces attached together. The foot ring 14 includes a base 30 having inner and outer surfaces 32 and 34 and a central portion 36 with an opening 38 extending therethrough. The base 30 additionally has a channel 40 extending around and outward from the central portion 36 on the inner surface 34 for receiving the collar 20, and a ledge 42 extending around and inward from a bottom of the central portion 36 for receiving a sensor assembly 210 as described in detail below. The base 30 may have a suitable shape to match the geometry of the gas tank 12, and as shown is substantially circular in shape. Extending around and upward from an outer peripheral surface 48 of the base 30 is a skirt 44 having an inner surface 46 configured to abut the gas tank 12.

The foot ring 14 also includes a plurality of circumferentially spaced feet 50 extending from the outer surface 32 of the base 30 for contacting a surface, such as a floor of a building, and a plurality of circumferentially space supports 52 extending radially inwardly from each of the feet 50. As shown, the foot ring 14 includes the plurality of circumferentially spaced feet 50 extending from the outer surface 36 at the periphery of the base 30. The plurality of circumferentially spaced feet 50 and supports 52 each include at least one opening 54, 56 respectively, extending therethrough for material savings and to allow liquid, such as water, to drain through the feet 50 and supports 52 from within an inner area of the foot ring 14. As shown, each of the plurality of circumferentially spaced feet 50 include two openings 54 circumferentially spaced from one another and extending through the respective one of the plurality of circumferentially spaced feet 50 and each of the plurality of circumferentially spaced supports 52 include one opening 56 extending therethrough. The plurality of circumferentially spaced feet 50 are separated from adjacent ones of the plurality of circumferentially spaced feet 50 by recesses 58 extending toward the inner surface 32.

The plurality of circumferentially spaced supports 52 are connected to the central portion 36 by a respective connector 60 and are separated from adjacent ones of the plurality of circumferentially spaced supports 52 by a plurality of circumferentially spaced shock absorbing members 70. The connectors 60 have a top surface 62 defining a bottom of the channel 40 and a bottom surface 64 having indicia 66, 68 or suitable marking as will be described below. The shock absorbing members 70 extend from the inner surface 32 to form cavities 72 in the outer surface 34 between circumferentially adjacent ones of the plurality of circumferentially spaced supports 52. The shock absorbing members 70 are provided to absorb a shock, for example if the portable gas cylinder 10 was dropped on the surface, thereby preventing damage to the gas tank 12. For example, the shock absorbing members 70 can deform or bend to absorb energy without causing damage to the gas tank 12. The plurality of circumferentially spaced shock absorbing members 70 are angled to abut and conform to the lower portion 18 of the gas tank 12. A support rib 74 is provided between adjacent ones of the plurality of shock absorbing members 70, a support spacer 76 is provided between each of the shock absorbing members 70 and the inner surface 46 of the skirt 44, and a support spacer 78 is provided between each support rib 74 and the inner surface 46 of the skirt 44.

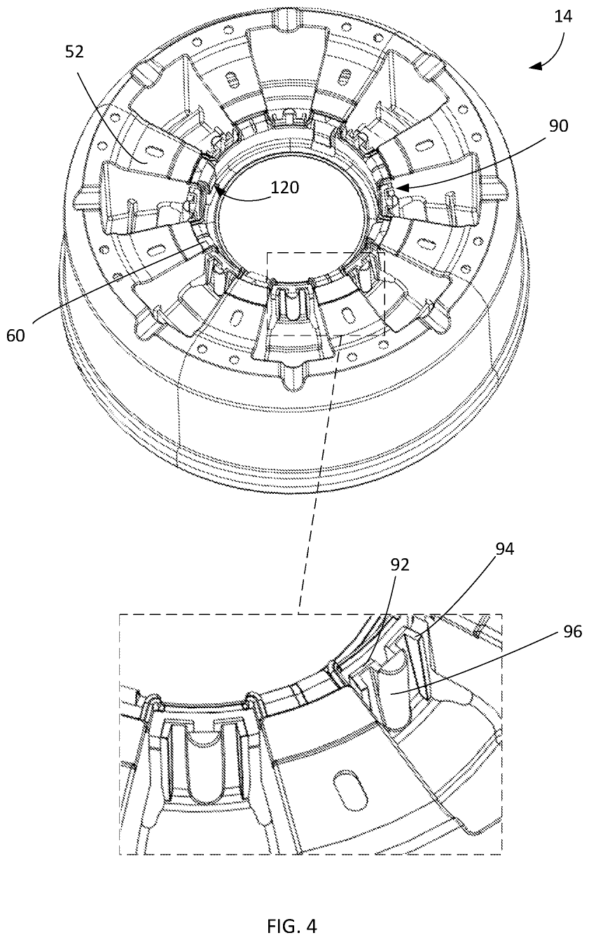

As best shown in FIG. 4, the foot ring 14 additionally includes a plurality of circumferentially spaced deflectable lock tabs 90 extending downward from radially inner ends of the shock absorbing members 70 toward the outer surface 34 and being radially outwardly spaced from the central portion 36 for securing the foot ring 14 to the gas tank 12. When engaged with the collar 20 of the gas tank 12, the deflectable lock tabs 90 prevent movement of the foot ring 14 in a longitudinal direction parallel to an axis of the gas tank 12. Each deflectable lock tab 90 includes a first portion 92 that abuts an outer surface of the base 22, and as shown a pair of first portions 92 in the form of longitudinal portions. The first portions 92 define a radially outer portion of the channel 40 and are angled towards the central portion 36 and each have an inner surface that is configured to abut a radially outer surface of the base 22 of the collar 20. Each deflectable lock tab 90 also includes one or more second portions 94 in the form of outwardly protruding arms extending radially outward from each first portion 92 for abutting an underside of the flange 24, and as shown a pair of second portions 94 extending from each first portion 92, and a third portion or central projection 96 extending radially outwardly from the inner projections 94 and having a backside that abuts or is in close proximity to a radially outer surface of the flange 24. As shown, the projection 96 is shaped like a cylindrical segment and can serve as an area for receiving a removal tool for removing the foot ring 14 from the gas tank 12.

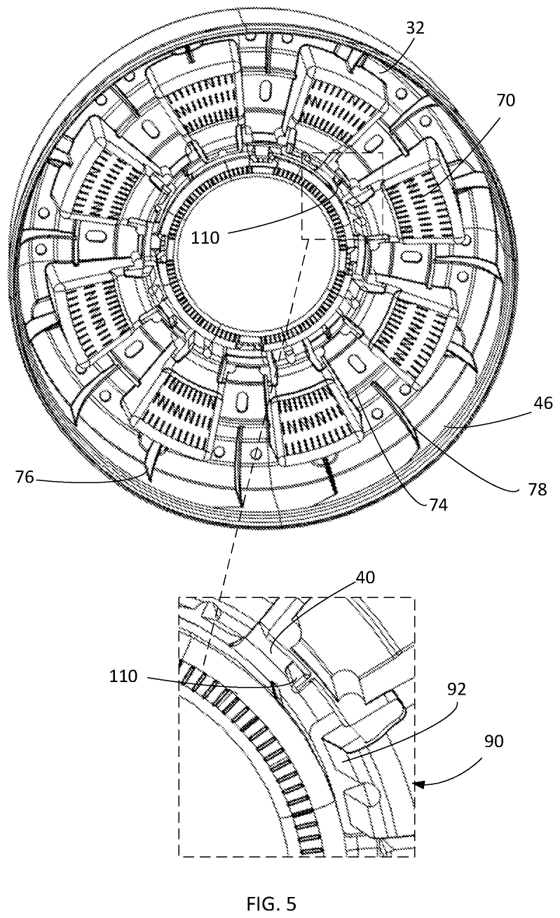

As best shown in FIG. 5, the foot ring 14 additionally includes a plurality of circumferentially spaced rotational lock tabs 110 for preventing rotational movement of the foot ring 14 relative to the gas tank 12 when the foot ring 14 is secured to the gas tank 12. The lock tabs 110 are shaped to fit within one of the notches 26 in the collar 20 to prevent rotational movement of the foot ring 14 relative to the collar 20 in a circumferential direction. As shown, the plurality of circumferentially spaced rotational lock tabs 110 extend radially inwardly from radially inner ends of the circumferentially spaced supports 52 toward the central portion 36 in the channel 40, and are fixed relative to the base 30 such that they do not deflect. Any suitable number of rotational lock tabs 110 may be provided, and as shown, four are provided, one on every other circumferentially spaced support 52. When a user is viewing the bottom of the foot ring 14, the location of the rotational lock tabs 110 can be identified by the indicia 66 on the bottom surface 64 of the connectors 60. The indicia 66 may be a suitable shape and/or color, such as an obround shape as shown to assist in locating the foot ring 14 relative to the collar 20.

As best shown in FIG. 3, the foot ring 14 additionally includes a plurality of circumferentially spaced lock members 120 for connecting to the sensor assembly 210. The circumferentially spaced lock members 120 may extend inwardly from the central portion 36 and be aligned with a respective one of the indicia 68 that identifies the location of the lock members 120. The indicia 68 may be a suitable shape and/or color, such as an arrow shape as shown to assist in locating sensor assembly 210 relative to the foot ring 14. Each circumferentially spaced lock member 120 may include a plurality of circumferentially spaced teeth 122 facing upward to face the ledge 42.

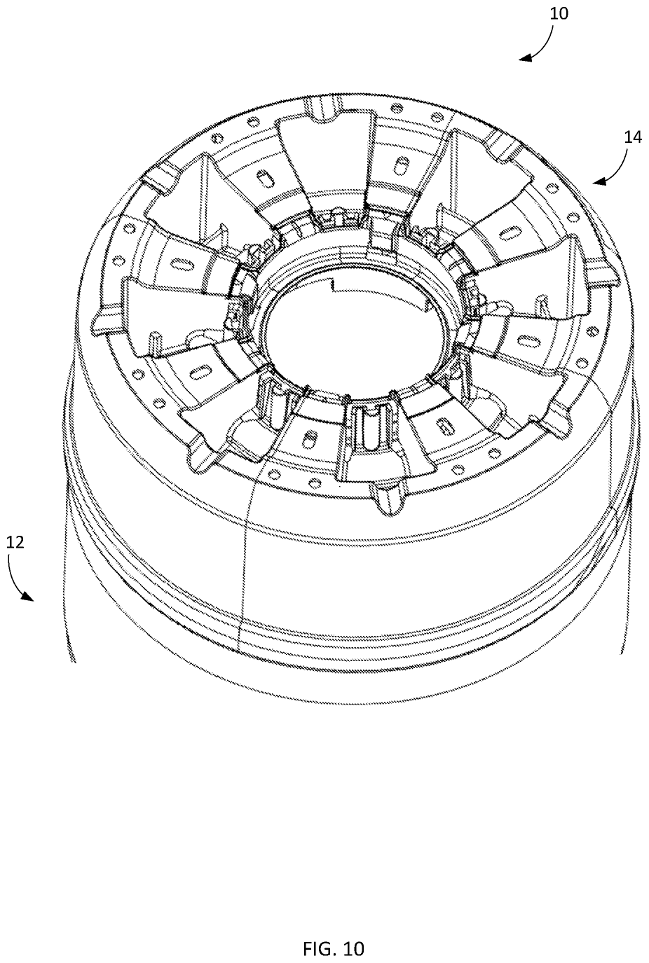

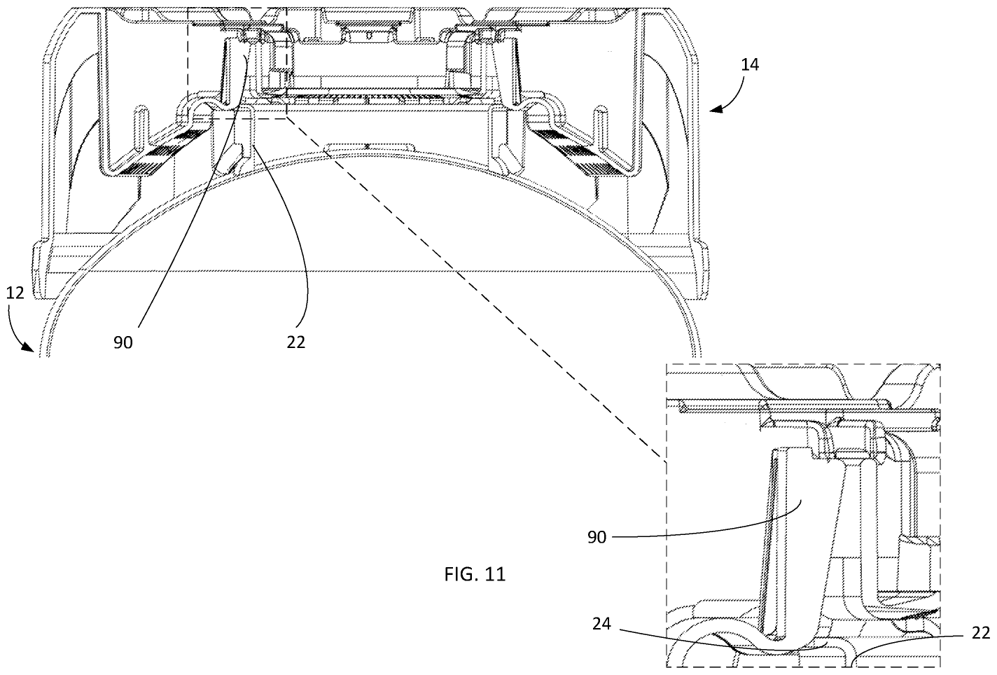

Turning now to FIGS. 10-15, the attachment of the foot ring 14 to the gas tank 12 will be described in detail. Referring initially to FIG. 10 and, the foot ring 14 is shown being lowered onto the gas tank 12 while the gas tank 12 is upside down. As the foot ring 14 is being lowered, the indicia 66 on the foot ring 14 indicating the location of the rotational lock tabs 110 are aligned with the notches 26 on the collar 20. It will be appreciated that the foot ring 14 and gas tank 12 may be in any suitable position for attachment, and that the attachment may be done by hand or by a machine, such as on an assembly line.

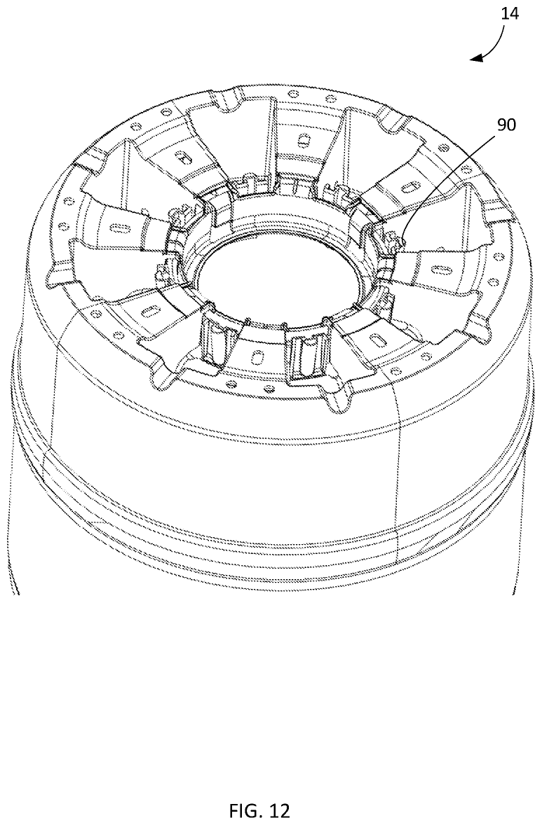

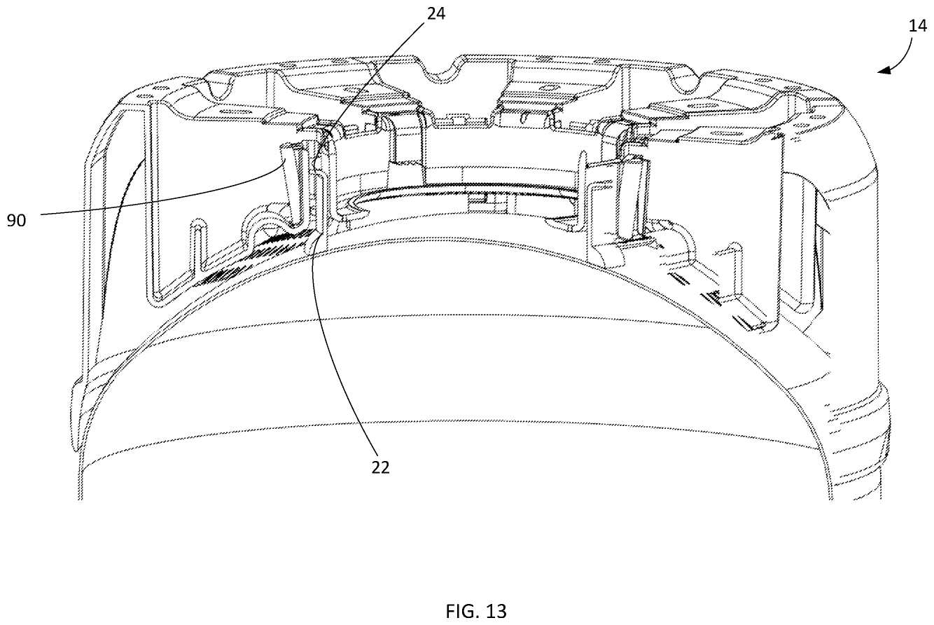

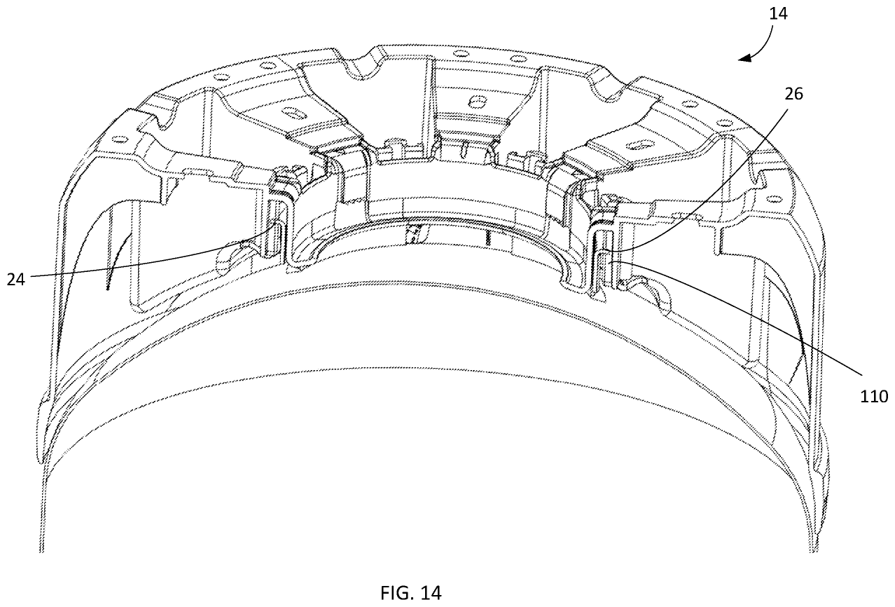

Referring next to FIGS. 12-14, the foot ring 14 is shown in a position prior to attachment to the gas tank 12. As best shown in FIG. 13, as the foot ring 14 is lowered onto the gas tank 12, the plurality of circumferentially spaced deflectable lock tabs 90 come in contact with the flange 24 of the collar 20 and are deflected radially outwardly. As best shown in FIG. 14, during lowering, the plurality of circumferentially spaced rotational lock tabs 110 are received in a respective one of the notches 26 to prevent rotation of the foot ring 14 relative to the gas tank 12.

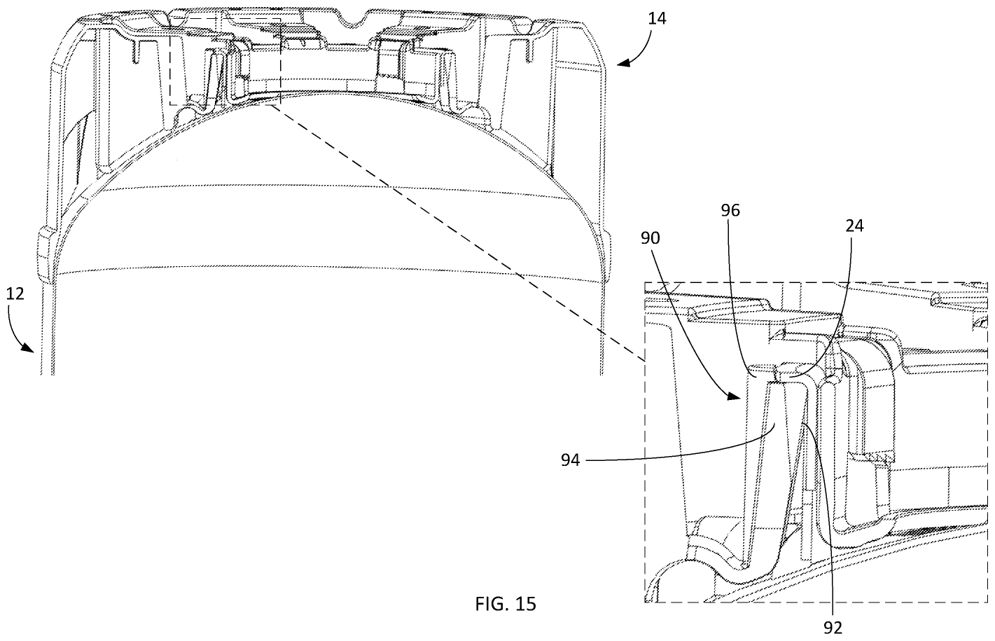

Referring next to FIGS. 1 and 15, the foot ring 14 is shown engaged with the gas tank 12. As the foot ring 14 is lowered from the position shown in FIGS. 12-14 to the position shown in FIGS. 1 and 15, the plurality of circumferentially spaced deflectable lock tabs 90 have moved beyond the flange 24 such that the first portions 92 of the tabs 90 abut an outer surface of the base 22 or are in close proximity thereto, the second portions 94 are engaged with the underside of the flange 24 to prevent movement of the foot ring 14 relative to the gas tank 12, and the central projections 96 abut or are in close proximity to the radially outer surface of the flange 24. The plurality of circumferentially spaced deflectable lock tabs 90 are thereby in an unbiased position and the foot ring 14 is secured to the tank 12 in the longitudinal direction. The foot ring 14 will also be secured against rotational movement by the plurality of circumferentially spaced rotational lock tabs 110.

To remove the foot ring 14 from the gas tank 12, a tool, such as a tool having the same number of tool portions as the tank has deflectable lock tabs 90, is positioned over the foot ring such that each tool portion is positioned between a backside of the respective central projection and the radially outer surface of the flange 24. The tool portions are then advanced towards the gas tank 12 causing the deflectable lock tabs 90 to deflect radially outwardly from under the flange 24 until the second portions 94 are disengaged from the flange. The foot ring 14 can then be moved in a direction away from the gas tank 12.

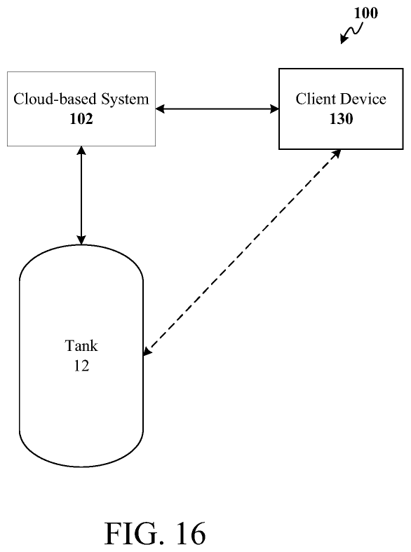

Turning now to FIG. 16, a schematic block diagram of an exemplary, non-limiting embodiment of an Internet-enabled tank management system is shown at reference numeral 100. System 100 can include a gas tank 12, which is communicatively coupled to a cloud-based system 102 and/or a client device 130 (e.g. smart phone, computer, portable computing device, etc.), for example, by way of a sensor assembly 210. The client device 130 may also be communicatively coupled with the cloud-based system 102.

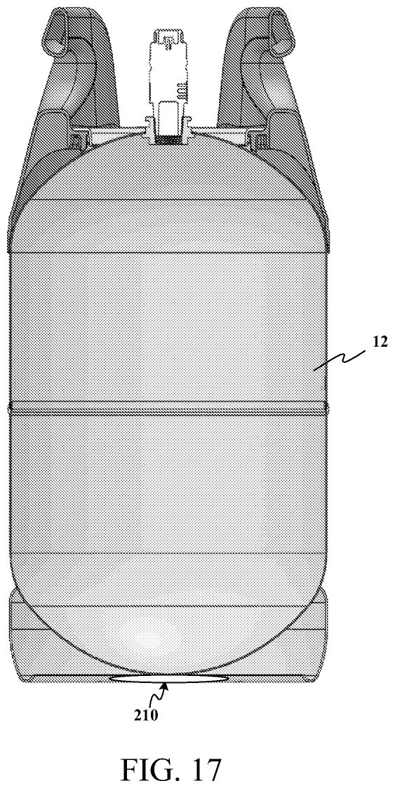

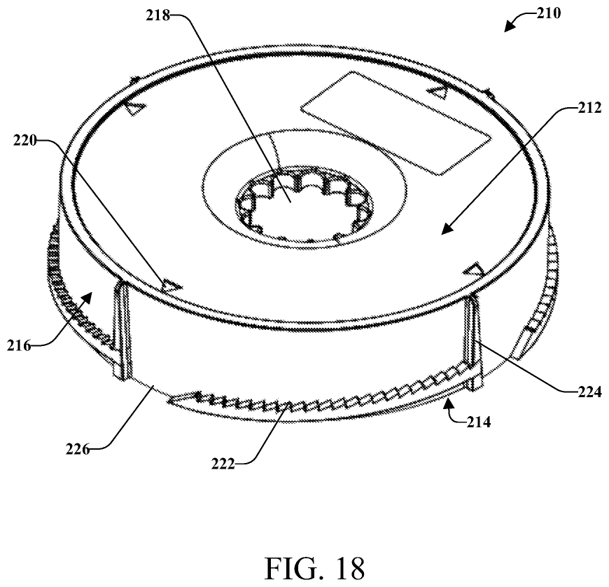

As shown in FIG. 17, tank 12 may be a portable gas cylinder. The sensor assembly 210 is provided on the gas tank 12. For example, as shown in FIG. 17, the sensor assembly 210 may be housed within the foot ring 14, directly beneath the gas tank 12. The sensor assembly 210 is configured to be inserted into, and coupled within the foot ring 14. While in position within the foot ring 14, the sensor assembly 210, can detect the volume of a liquid within the gas tank 12 by, for example, detecting the amount of force that the gas tank 12 exerts on one or more sensors within the sensor assembly 210. Turning to FIG. 18, a more detailed illustration of sensor assembly 210 is depicted. Sensor assembly 210 includes a housing having a first surface 212, a second surface 214 opposite the first surface 212, and a cylindrical sidewall 216 extending between the first surface 212 and the second surface 214. The housing can be constructed of any suitable material or combination of materials, such as one or more of a plastic, a rubber, a metal, nylon, or silicone.

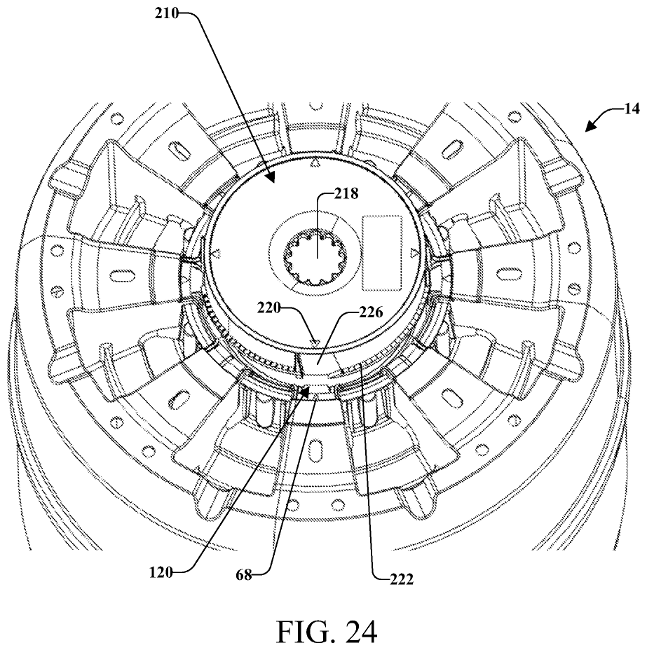

The sensor assembly 210 also includes certain features and components to facilitate the coupling of the sensor assembly 210 within a foot ring 14 as described in greater detail below with respect to FIGS. 24-28. The first surface 212 can include a tool receptacle 218 for receiving a tool that allows a user to provide a rotational force to the sensor assembly 210. The tool receptacle 218 can be, for example, a screw head such as a straight screw head, a Phillips screw head, or a hex screw head, among others. The first surface 212 can also include one or more alignment indicators 220. The alignment indicators 220 can provide a visual indication to a user to assist in rotationally aligning the sensor assembly 210 as necessary during installation into the foot ring 14. The alignment indicators 220 can be, for example, arrows, notches, lines, or dots, among others. Still further, the cylindrical sidewall 216 can include a plurality of toothed ramps 222 extending along a circumference of the cylindrical sidewall 216. Each toothed ramp 222 begins proximate to the second surface 214 and extends along a circumference of the cylindrical sidewall 216. As the toothed ramp 222 extends along the circumference of the cylindrical sidewall 216, the distance between the teeth of the toothed ramp 222 and the first surface 212 decreases. Each toothed ramp 222 extends until it terminates at a vertical detent 224. An insertion slot 226 is the gap created between each vertical detent 224 and a neighboring toothed ramp 222. The cylindrical sidewall 216 can include a plurality of insertion slots 226, with one or more of the insertion slots 226 aligned with a corresponding alignment indicator 220.

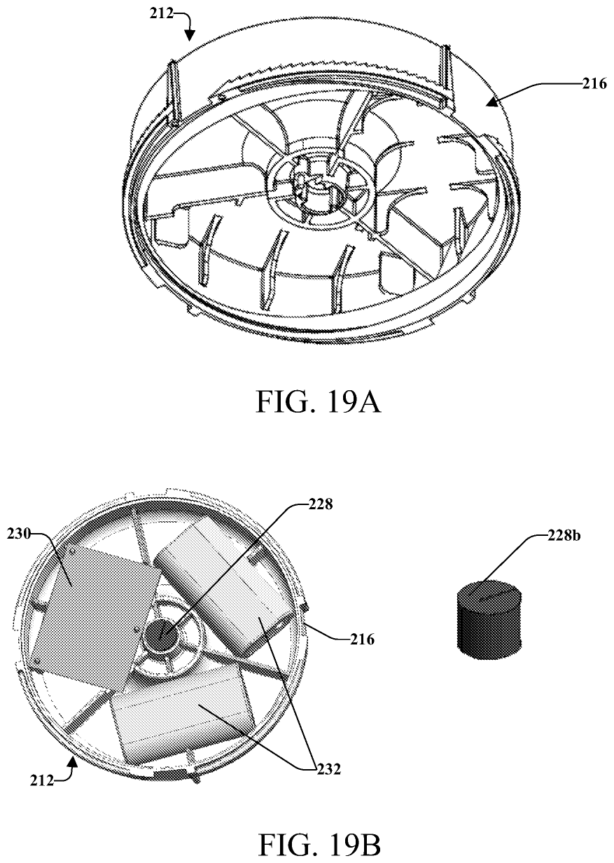

The sensor assembly 210 housing encloses various internal components of the sensor assembly 210. Turning now to FIGS. 19A and 19B, an interior view of the sensor assembly 210 is shown. While in the embodiment shown in FIGS. 19A and 19B, the first surface 212 and the cylindrical sidewall 216 are formed as a single component, it should be appreciated that in other embodiments, the cylindrical sidewall 216 can be formed with the second surface 214 as a single component, or first surface 212, second surface 214, and cylindrical sidewall 216 can each be individual components that are joined together. In one embodiment, the first surface 212 and the cylindrical sidewall 216 are constructed of nylon. As shown in FIG. 19A, an interior of the first surface 212 and/or an interior of the cylindrical sidewall 216 can include various clips, spacers, or brackets to provide compartments for holding the internal components shown in FIG. 19B.

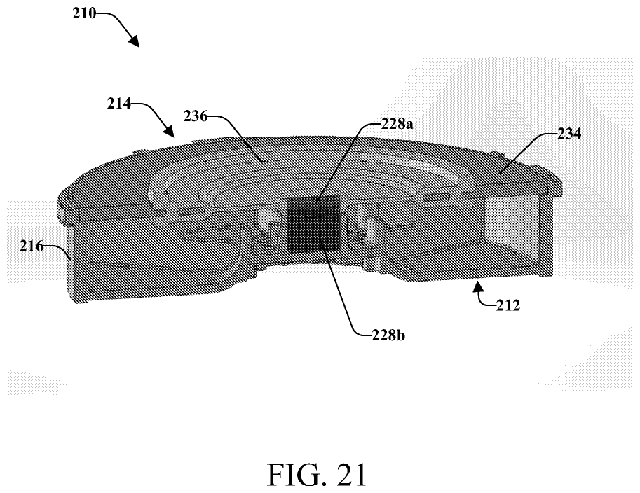

Specifically, the sensor assembly 210 can house one or more sensors 228. The one or more sensors 228 can be, for example, a piezoelectric transducer 228a (as seen in FIG. 21) or an ultrasound sensor. In one embodiment, the one or more sensors 228 is a piezoelectric transducer 228a that can measure a volume of liquid or gas within the gas tank 12 based on a force applied by the gas tank 12 to the piezoelectric transducer 228a. The force applied to the piezoelectric transducer 228a produces a voltage that can then be correlated to the amount of force applied, and therefore allowing a corresponding volume of the gas tank 12 to be determined. In certain embodiments, the one or more sensors 228 can be placed and/or mounted within a central receptacle in an underside of the first surface 212. The one or more sensor 228 is shown within its central receptacle. In embodiments where the one or more sensor 228 includes a piezoelectric transducer 228a, a damper 228b can also be included to provide a force to the piezoelectric transducer 228a and maintain the piezoelectric transducer 228a in place and pressed against the second surface 214. An exemplary damper 228b is shown enlarged in FIG. 19B. Sensor assembly 210 further includes a control circuit 230. The control circuit 230 can, for example, be a printed circuit board (PCB). The control circuit 230 can be mounted within the sensor assembly 210 housing by way of one or more fasteners such as screws. In another embodiment, the control circuit 230 is clipped, snapped, or friction fit into a receptacle on an underside of the first surface 212. Sensor assembly 210 can further include one or more power sources 232 within the sensor assembly 210 housing. The one or more power sources 232 can be, for example, one or more batteries. The one or more power sources 232 can be mounted within the sensor assembly 210 housing by way of one or more fasteners. In another embodiment, the one or more power sources 232 are clipped, snapped, or friction fit into a receptacle on an underside of the first surface 212. The one or more power sources 232 can be electrically coupled to the control circuit 230 and/or the one or more sensors 228 (e.g. by wires), and are configured to provide power to these components.

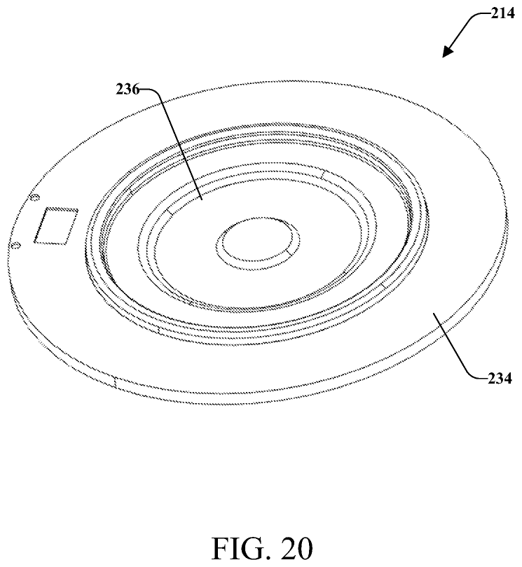

FIG. 20 shows an embodiment of the second surface 214. The second surface 214 can include multiple components. In certain embodiments, the second surface 214 can include an outer ring 234 and an inner disc 236. The outer ring 234 and the inner disc 236 can be over-molded by way of an injection molding process. In one embodiment, the outer ring 234 is made from a rigid or semi-rigid material such as nylon, and the inner disc is made of an elastomeric material such as silicone. The outer ring 234 can be molded together with the inner disc 236 such that the inner disc 236 is molded over a portion of the outer ring 234. The second surface 214 can be attached to the cylindrical sidewall 216 using a fastener, an adhesive, or a joining process such as a weld. In one embodiment, the second surface 214 is joined to the cylindrical sidewall 216 using an ultrasonic welding process. A cross-sectional view of the sensor assembly 210 showing an assembled embodiment of the sensor assembly 210 and the location of the one or more sensor 228 within the sensor assembly 210 is depicted in FIG. 21. The one or more sensor 228 can make physical contact with the inner disc 236 of the second surface 214. For example, the piezoelectric damper 228b can nest within a central receptacle of an inside of the first surface 212. The piezoelectric transducer 228a can be placed on top of the piezoelectric damper 228b, while making contact with an inside of the inner disk 236 of the second surface 214. In other words, the piezoelectric transducer 228a and damper 228b are sandwiched in between the first surface 212 and the second surface 214.

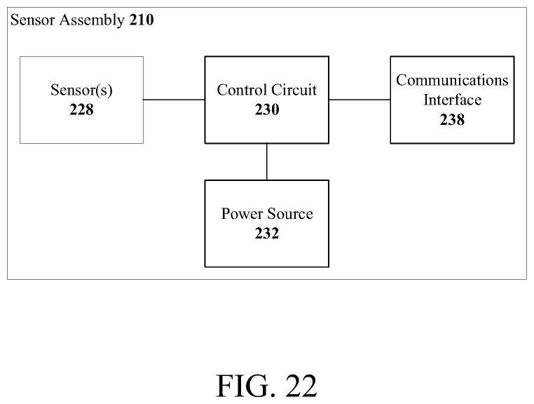

Turning to FIG. 22, a schematic diagram of sensor assembly 210 is illustrated. Sensor assembly 210 includes one or more sensors 228, such as a piezoelectric transducer 228a or an ultrasound sensor, coupled to a control circuit 230, which is powered by power source 232, such as a battery. The one or more sensor 228 provides a sensor reading (e.g. a voltage based on a pressure or force exerted on it, or an ultrasound signal) to control circuit 230.

In one example, the control circuit 230 may interpret the sensor reading from a piezoelectric transducer 228a into a fluid level. The fluid level may be stored by control circuit 230 and/or communicated, via a communications interface 238, to cloud-based system 102 and/or client device 130.

In another example, the control circuit 230 may interpret a temperature signal from a temperature sensor. The control circuit 230 may store or communicate the temperature reading. In another aspect, the control circuit 230 may compare the temperature reading to a threshold and issue an alarm, for example, via communications interface 238, when the temperature reading exceeds the threshold.

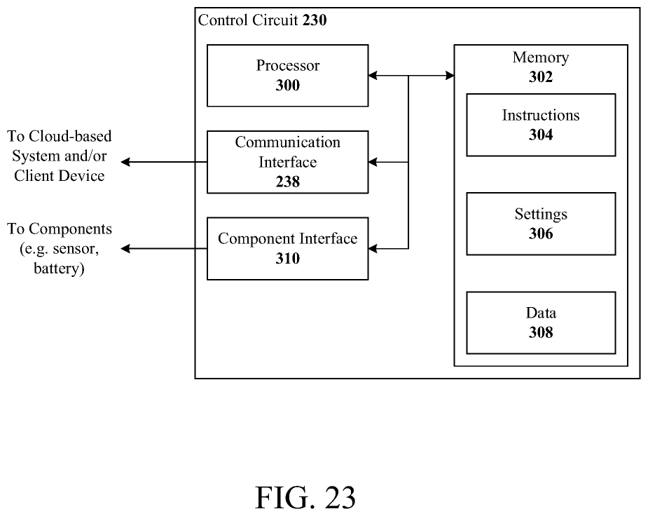

Turning to FIG. 23, illustrated is a schematic block diagram of an exemplary, non-limiting embodiment for control circuit 230. As shown in FIG. 23, control circuit 230 includes one or more processor(s) 300 configured to executed computer-executable instructions 304 such as instructions composing a control and communication process for sensor assembly 210. Such computer-executable instructions can be stored on one or more computer-readable media including non-transitory, computer-readable storage media such as memory 302. For instance, memory 302 can include non-volatile storage to persistently store instructions 304, settings 306 (e.g. configuration settings, calibration settings, identification information, etc.), and/or data 308 (e.g., sensor data, battery status, etc.). Memory 302 can also include volatile storage that stores instructions 304, other data (working data or variables), or portions thereof during execution by processor 300.

Control circuit 230 includes a communication interface 238 to couple control circuit 230, via the Internet or other communications network, to various remote systems such as, but not limited to, backend systems, client devices, other controllers, or Internet-enabled devices (e.g., IoT sensors). Communication interface 238 can be a wired or wireless interface including, but not limited, a WiFi interface, an Ethernet interface, a Bluetooth interface, a fiber optic interface, a cellular radio interface, a satellite interface, etc. The communications interface 238 can be configured to communicate with client devices and/or cloud-based systems through a local area network co-located with the tank system (e.g. a home network) as described above. The communications settings, thus established, can be stored in memory 302. According to various embodiments, the communication interface 238 may utilize communication technologies such as, but not limited to, SigFox, NB-IoT, 4G, 5G, Lora, a short-range RF interface (Bluetooth), WiFi or the like.

Using the communication interface 238, the control circuit 230 may carry out wireless sniffing. In particularly, the control circuit 230 may utilize the communication interface 238 to locate nearby wireless access points, determine respective signal strengths, etc. Such information may facilitate geo-locating the gas tank 12, for example.

A component interface 310 is also provided to couple control circuit 230 to various components of the sensor assembly 210. For instance, component interface 310 can connect control circuit 230 to the one or more sensors 228 (such as piezoelectric transducer 228a and/or ultrasound sensor) or input/output devices (e.g., buttons, indicators, LEDs, displays, etc.). Via the component interface 310, the control circuit 230 can acquire readings from the one or more sensors 228. Accordingly, component interface 310 can include a plurality of electrical connections on a circuit board or internal bus of control circuit 230 that is further coupled to processor 300, memory 302, etc. Further, the component interface 310 can implement various wired or wireless interfaces such as, but not limited to, a USB interface, a serial interface, a WiFi interface, a short-range RF interface (Bluetooth), an infrared interface, a near-field communication (NFC) interface, etc.

Sensor assembly 210 is configured to be insertably coupled within the foot ring 14, such that the sensor assembly 210 is located directly beneath the gas tank 12. Turning now to FIG. 24, the sensor assembly 210 is shown in proper alignment to be inserted into the opening 38 of the foot ring 14. For example, a user can align the alignment indicators 220 on the first surface 212 of the sensor assembly 210 with the indicia 68 on the foot ring 14. When the alignment indicators 220 are aligned with the indicia 68, the insertion slots 226 are aligned with the corresponding lock member 120 of the foot ring 14. A user can insert the sensor assembly 210 into the central portion 36 of the foot ring 14 such that the lock members 120 of the foot ring 14 slide into the insertion slots 226 and the sensor assembly 210 abuts or is in close proximity to the ledge 42.

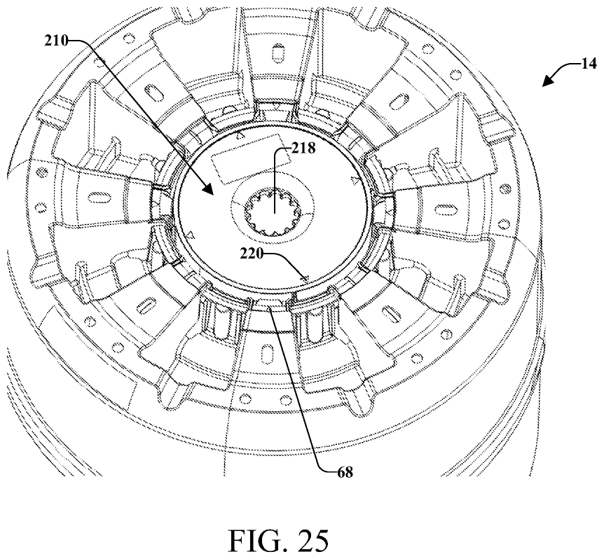

When the sensor assembly 210 is inserted into the central portion 36, a user can insert a tool into the tool receptacle 218. The tool can be, for example, a screwdriver, a wrench, a drill head, or any other tool capable of providing a rotational force to the sensor assembly 210. It should be appreciated that an end of the tool can correspond with the tool receptacle in shape. A user can operate the tool to rotate the sensor assembly 210 such that the toothed ramp 222 engages with the teeth 122 located on the foot ring 14. As the sensor assembly 210 is rotated, the teeth 122 engage with the toothed ramp 222 in a ratchet-like manner, allowing continued rotation in a tightening direction (e.g. clockwise), but preventing a reverse rotation in a loosening direction. Each successive engagement of a subsequent tooth of the toothed ramp with the teeth 122 tightens the sensor assembly 210 into the foot ring 14, thereby providing a force between a bottom of the gas tank 12 and the second surface 214 of the sensor assembly 210. In certain embodiments, the tool is configured to provide a predetermined amount of rotational force to the tool receptacle 218. The predetermined amount of rotational force provides a predetermined amount of tightening of the sensor assembly 210 within the foot ring 14, and therefore a predetermined amount of force applied by the bottom of the gas tank 12 to the one or more sensors 228 within the sensor assembly 210. This allows the one or more sensors 228 to be properly calibrated to the predetermined amount of force provided by the gas tank 12 while the sensor assembly 210 is coupled within the foot ring 14. FIG. 25 depicts an embodiment when the sensor assembly 210 has been inserted within the opening 38, and rotated by a tool. As depicted, the alignment indicators 220 on the first surface 212 of the sensor assembly 210 and the indicia 68 on the foot ring 14 move out of alignment when the sensor assembly 210 is rotated and therefore tightened within the foot ring 14.

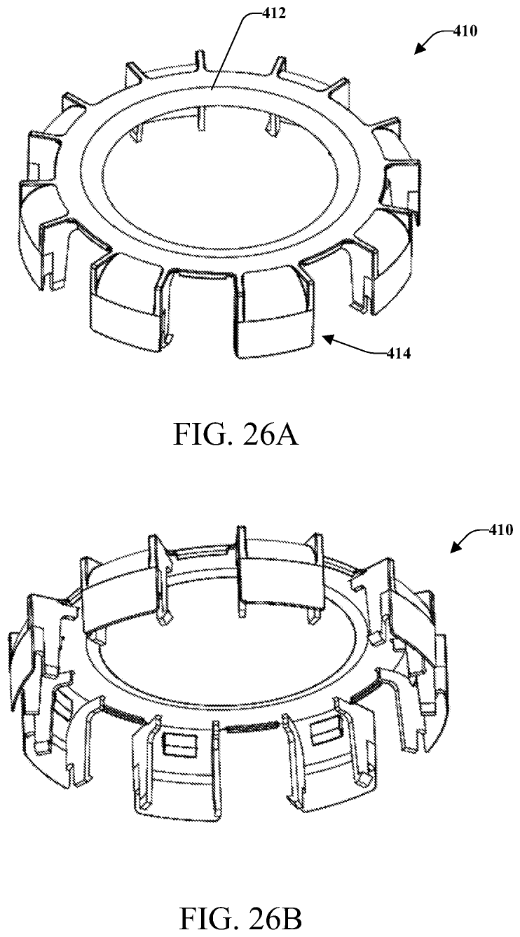

Turning now to FIGS. 26A and 26B, a locking ring 410 is shown. Locking ring 410 can include an inner ring portion 412 with a plurality of clips 414 extending downwards, perpendicular from the surface of the inner ring portion 412. The locking ring 410 is configured to be inserted into the foot ring 14 such that the inner ring portion 412 overlaps at least a portion of the sensor assembly 210 while the sensor assembly 210 is inserted and coupled within the opening 38 of the foot ring 14.

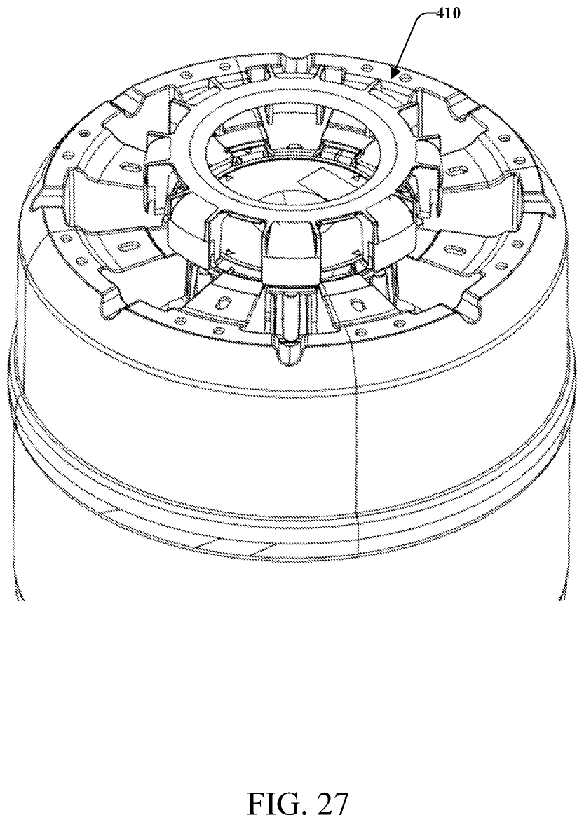

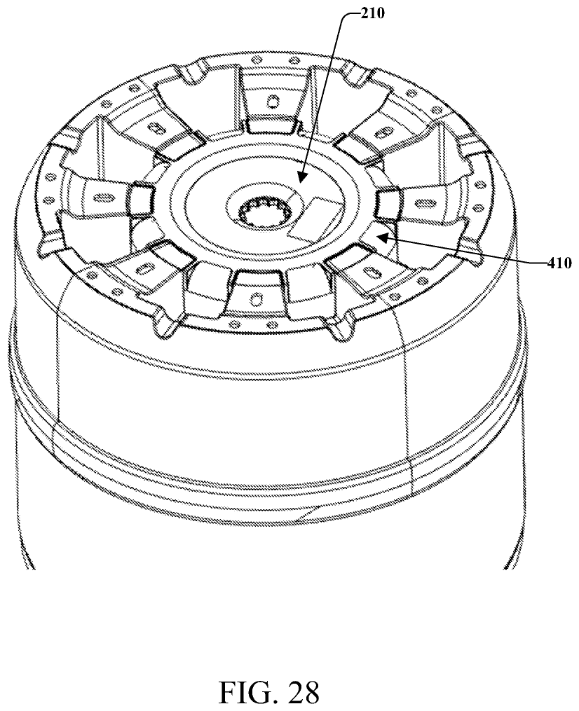

As shown in FIG. 27, each clip of the plurality of clips 414 can be aligned with a corresponding cavity 72 of the foot ring 14. A user can then insert the locking ring 410 into the foot ring 14 such that each of the clips 414 is inserted into each corresponding cavity 72 and the inner ring portion 412 at least partially overlaps the sensor assembly 210 as shown in FIG. 28, thereby further preventing removal of the sensor assembly 210. The plurality of clips 414 can include various features configured to engage with a corresponding feature of the foot ring 14 to prevent removal of the locking ring 410 once the locking ring 410 is inserted into the foot ring 14. In certain embodiments, the clips 414 can be inwardly biased such that while the clips 414 are being inserted into the corresponding cavity 72, the clip 414 can deflect outwards, and then deflect back inwards when the clips are fully inserted, to latch onto a feature of the foot ring 14 to prevent removal.

The aforementioned systems, components, (e.g., foot, cylinders, among others), and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

While the embodiments discussed herein have been related to the systems and methods discussed above, these embodiments are intended to be exemplary and are not intended to limit the applicability of these embodiments to only those discussions set forth herein.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur — this distinction is captured by the terms “may” and “may be.”

The best mode for carrying out the invention has been described for purposes of illustrating the best mode known to the applicant at the time and enable one of ordinary skill in the art to practice the invention, including making and using devices or systems and performing incorporated methods. The examples are illustrative only and not meant to limit the invention, as measured by the scope and merit of the claims. The invention has been described with reference to preferred and alternate embodiments. Modifications and alterations will occur to others upon the reading and understanding of the specification. It is intended to include all such modifications and alterations insofar as they come within the scope of the appended claims or the equivalents thereof. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A foot ring configured to be secured to a tank having a collar, the foot ring comprising:
a base having an inner and outer surface and a central portion;
a plurality of circumferentially spaced deflectable longitudinal lock tabs radially outwardly spaced from the central portion for securing the foot ring to the tank, each of the circumferentially spaced deflectable longitudinal lock tabs having a first portion for abutting a radially outer surface of a base of the collar and a second portion for engaging an underside of a flange of the collar that extends radially outwardly from the base of the collar; and
a plurality of circumferentially spaced rotational lock tabs radially outwardly spaced from the central portion, each of the circumferentially spaced rotational lock tabs configured to be received in a respective notch in the flange to prevent rotational movement of the foot ring relative to the tank.

2. The foot ring according claim 1, further comprising indicia on the outer surface of the base corresponding to a location on the inner surface of the base of each of the plurality of circumferentially spaced rotational lock tabs.

3. The foot ring according to claim 1, wherein the circumferentially spaced rotational lock tabs are fixed relative to the base.

4. The foot ring according to claim 1, further including a plurality of circumferentially spaced lock members extending radially inwardly from the central portion for connecting to a sensor assembly.

5. The foot ring according to claim 4, wherein each of the plurality of circumferentially spaced lock members includes a plurality of circumferentially spaced teeth.

6. The foot ring according to claim 1, further including a plurality of circumferentially spaced shock absorbing members extending from the inner surface.

7. The foot ring according to claim 6, wherein the plurality of circumferentially spaced deflectable longitudinal lock tabs extend from radially inner ends of the shock absorbing members toward the outer surface.

8. A portable gas cylinder comprising:
a gas tank having an upper portion, a lower portion, and a collar, the collar including a base secured to the lower portion, a flange extending around and radially outwardly from the base, and a plurality of notches circumferentially spaced around the flange; and
a foot ring configured to be attached to the gas tank, the foot ring including:
a base having an inner surface, an outer surface, a central portion, and a ledge extending around and inward from the central portion;
a plurality of circumferentially spaced deflectable longitudinal lock tabs radially outwardly spaced from the central portion for securing the foot ring to the tank; and
a plurality of circumferentially spaced rotational lock tabs radially outwardly spaced from the central portion.

9. The portable gas cylinder according to claim 8, wherein each of the circumferentially spaced deflectable longitudinal lock tabs have a first portion for abutting a radially outer surface of the base of the collar and a second portion for engaging an underside of the flange of the collar.

10. The portable gas cylinder according to claim 8, wherein each of the circumferentially spaced rotational lock tabs are configured to be received in a respective one of the notches to prevent rotational movement of the foot ring relative to the gas tank.

11. The portable gas cylinder according to claim 8, further including a plurality of circumferentially spaced lock members extending radially inwardly from the central portion for connecting to a sensor assembly, wherein each of the plurality of circumferentially spaced lock members includes a plurality of circumferentially spaced teeth facing the ledge.

12. The portable gas cylinder of claim 11, further comprising a sensor assembly configured to measure one or more parameters of the gas tank, wherein the sensor assembly includes a housing that comprises:
a first surface,
a second surface opposite the first surface, and
a cylindrical sidewall extending between the first surface and the second surface, wherein the cylindrical sidewall includes a plurality of toothed ramps extending along a circumference of the cylindrical wall, and wherein the plurality of toothed ramps are configured to engage with the plurality of circumferentially spaced teeth when the sensor assembly is inserted into an opening extending through the central portion of the foot ring.

13. The portable gas cylinder of claim 12, wherein the first surface of the sensor assembly includes a tool receptacle configured to receive a tool that can apply a rotational force to the sensor assembly.

14. The portable gas cylinder of claim 12, wherein the toothed ramps and the plurality of circumferentially spaced teeth engage such that the sensor assembly can be tightened within the opening in a first rotational direction, but cannot be loosened within the opening in a second rotational direction.

15. The portable gas cylinder of claim 12, wherein the second surface of the sensor assembly includes an elastomeric surface.

16. The portable gas cylinder of claim 12, wherein the sensor assembly further comprises:
one or more sensors configured to detect the one or more parameters of the gas tank;
a control circuit configured to receive a measurement of the one or more parameters from the one or more sensors, and transmit a signal containing the measurement; and
one or more power supplies configured to supply power to at least one of the one or more sensors or the control circuit,
wherein the one or more sensors, the control circuit, and the one or more power supplies are enclosed within the housing.

17. The portable gas cylinder of claim 16, wherein the one or more sensors is a piezoelectric transducer.

18. A sensor assembly configured to measure one or more parameters of a gas tank, the sensor assembly comprising:
one or more sensors configured to detect one or more parameters of the gas tank;
a control circuit configured to receive a measurement of the one or more parameters from the one or more sensors, and transmit a signal containing the measurement;
one or more power supplies configured to supply power to at least one of the one or more sensors or the control circuit; and
a housing that encloses the one or more sensors, the control circuit, and the one or more power supplies, wherein the housing comprises:
a first surface,
a second surface opposite the first surface, and
a cylindrical sidewall extending between the first surface and the second surface.

19. The sensor assembly of claim 18, wherein the cylindrical sidewall includes a plurality of toothed ramps extending along a circumference of the cylindrical sidewall.

20. The sensor assembly of claim 18, wherein the first surface includes a tool receptacle configured to receive a tool that can apply a rotational force to the sensor assembly.
